(19) United States
(12) Patent Application Publication
(10) Pub. No.: US 2020/0182747 A1
(43) Pub. Date: Jun. 11, 2020

(54) BSR TESTING USING VEHICLE ACTIVE SUSPENSION SYSTEMS

(71) Applicant: ClearMotion, Inc., Billerica, MA (US)

(72) Inventor: Michael W. Finnegan, Medford, MA (US)

(73) Assignee: ClearMotion, Inc., Billerica, MA (US)

(21) Appl. No.: 16/704,431

(22) Filed: Dec. 5, 2019

Related U.S. Application Data
(60) Provisional application No. 62/775,971, filed on Dec. 6, 2018.

(51) Int. Cl. G01M 17/04; G01M 7/02

(52) U.S. Cl. CPC G01M 17/04; G01M 7/025

(57) ABSTRACT

This disclosure describes a method for performing BSR testing on a vehicle with an active suspension system, the method including actuating at least one actuator of the active suspension system to induce vibration of a vehicle or at least one component of the vehicle at a first frequency, recording a first acoustic response generated by the vehicle or the at least one component in response to the induced vibration at the first frequency, and analyzing the first recorded acoustic response to identify a presence of one or more manufacturing defects associated with the vehicle or the at least one component. This disclosure also describes a method for characterizing resonance frequencies of a vehicle equipped with an active suspension system.

### RELATED APPLICATIONS

This Application claims the benefit of priority under 35 U.S.C. 119(e) of U.S. Provisional Application Ser. No. 62/775,971, filed Dec. 6, 2018, the disclosure of which is incorporated herein by reference in its entirety.

### FIELD

Embodiments described herein are related to methods and systems for utilizing vehicle active suspension systems for various diagnostic and related testing.

### BACKGROUND

Vehicles undergo numerous tests to determine certain vehicle characteristics relevant to vehicle performance and other vehicle features. Variations on testing regimes have been developed to further understand vehicle characteristics.

### SUMMARY

According to one aspect, the present specification discloses a method for performing BSR (buzz squeak rattle) testing on a vehicle equipped with an active suspension system. The method includes actuating at least one actuator of the active suspension system to induce vibration of a vehicle or at least one component of the vehicle in a first frequency range, recording a first acoustic response generated by the vehicle or the at least one component in response to the induced vibration in the first frequency, and analyzing the first recorded acoustic response to identify a presence of one or more defects associated with the vehicle or the at least one component.

In some implementations, the method includes actuating the at least one actuator of the active suspension system to induce vibration of the vehicle or the at least one component at a second frequency, recording a second acoustic response generated by the vehicle or the at least one component in response to the induced vibration at the second frequency, and analyzing the second acoustic response to identify a presence of one or more manufacturing defects associated with the vehicle or the at least one component.

In some implementations, analyzing the first recorded acoustic response includes comparing the first acoustic response to a reference acoustic response. In some instances, analyzing the first recorded acoustic response includes determining that the first recorded acoustic response deviates from the reference acoustic response. In some instances, the reference acoustic response includes an audio response recorded from the vehicle at a previous time. In some instances, the reference acoustic response includes an audio response recorded from another vehicle of the same make and model as the vehicle.

In some implementations, the method includes updating, by a controller, an electronic record associated with the vehicle. In some instances, updating the electronic record includes tagging the vehicle for a repair or a further inspection.

In some implementations, the at least one component of the vehicle comprises a body of the vehicle.

In some implementations, analyzing the first recorded audio response further includes determining that a differential between the first recorded acoustic response and the reference acoustic response is within a predetermined threshold.

In another aspect, the present specification discloses a method for characterizing resonance frequencies of a vehicle equipped with an active suspension system. The method includes actuating, over a range of frequencies, at least one actuator of the active suspension system to excite a component of the vehicle and analyzing an output of at least one accelerometer attached to the vehicle to determine resonance frequencies of the vehicle.

In some implementations, the method includes analyzing the resonance frequencies of the vehicle and associating at least one of the resonance frequencies with a vehicle component.

### BRIEF DESCRIPTION OF THE DRAWINGS

FIG. 1 shows a corner of a vehicle equipped with an active suspension system and a microphone to detect noise.

FIG. 2 shows a corner of a vehicle equipped with an active suspension system and an accelerometer to identify resonance frequencies.

### DETAILED DESCRIPTION

Many vehicles undergo a form of modal, end-of line testing method called buzz squeak and rattle (BSR) testing before the vehicles are sold to customers. BSR testing may be performed by mounting the vehicle on a four post lift and actuating the four post lift to excite different resonances in the vehicle body. Another method for performing BSR testing includes the vehicle being driven by a trained driver over a specialized testing road, wherein the road's surface has grooves designed to excite the vehicle body at various resonance frequencies. In both forms of BSR testing, vehicle resonances are excited while an operator, either in the vehicle or outside of the vehicle, listens for unwanted noise, or for vibrations that result in noise levels over a specified threshold. While BSR testing offers many advantages (e.g., increase in vehicle quality, increase in consistency of quality across multiple vehicles, etc.), oftentimes, performing BSR testing requires access to specialized equipment (e.g., a four post lift, specialized acoustic sensors, a specialized road) and may increase the time and cost associated with manufacturing and testing vehicles prior to release. Additionally, BSR testing performed by a human evaluator is highly subjective and outcomes are reliant on the skills and judgment of that human evaluator.

The inventors have recognized the benefits of using an active suspension system of a vehicle to conduct BSR testing. Disclosed herein are systems and methods for performing BSR testing on vehicles using one or more actuators of active suspension systems. In some embodiments, the methods described herein include vibrating a vehicle, or one or more components thereof, using one or more actuators of the active suspension system while measuring parameters influenced by the vibration. Some embodiments include measuring the sound produced in one or more frequency bands when the vehicle body is vibrated at various frequencies. Some embodiments include measuring an output of one or more accelerometers attached to the body of the vehicle to identify one or more resonance frequencies of the vehicle. Some embodiments include operating an actuator of the active suspension system at various conditions (e.g., at various torque-speed combinations) while measuring sound produced by, and/or acceleration response of, the excited vehicle to map conditions that may result in undesirable responses during normal vehicle operation.

In one embodiment, a method is disclosed for performing BSR testing on a vehicle equipped with an active suspension system. First, a testing mode is selected for the vehicle. This mode can be either manually selected by a person, or in the case of an automated BSR testing mode, the mode can be automatically initiated upon a predetermined triggering event. Examples of triggering events may include reaching a particular location in a production plant, reaching a particular point in a routine maintenance diagnostics program (e.g., BSR testing may be performed after a check of some other vehicle system or component), etc. In the testing mode, at least one of the actuators of the vehicle active suspension system may be actuated to vibrate the vehicle body or portion of the vehicle body at a first frequency or over a first range of frequencies. A first frequency may be about 5 Hz, about 8 Hz, about 10 Hz, about 12 Hz, about 20 Hz, about 40 Hz, about 60 Hz, about 80 Hz, about 100 Hz, etc. A first range of frequencies may be about 5 Hz to about 100 Hz, e.g., about 5 Hz to about 20 Hz, about 5 Hz to about 40 Hz, about 5 Hz to about 60 Hz, about 5 Hz to about 80 Hz, about 20 Hz to about 40 Hz, about 20 Hz to about 60 Hz, about 20 Hz to about 80 Hz, about 20 Hz to about 100 Hz, about 40 Hz to about 60 Hz, about 40 Hz to about 80 Hz, about 40 Hz to about 100 Hz, about 60 Hz to about 80 Hz, about 60 Hz to about 100 Hz, about 80 Hz to about 100 Hz, etc. The first frequency may be, or the first range of frequencies may include, a resonance frequency of the vehicle or vehicle body. Alternatively, other appropriate frequencies or frequency ranges may be chosen. The first frequency or first frequency range may be predetermined, or it may be chosen by an operator either before testing or during testing, as the disclosure is not limited in this regard. Components or elements of or within the vehicle that may be of interest (e.g., a sound system, a windshield, a rear-view mirror, a seat, a portion of loose trim, a seatbelt, etc.) may influence the selection of a frequency or a frequency range that is selected for initial testing. In some embodiments, an initial sweep over the first range of frequencies may be conducted, and then followed by further testing in narrower or broader frequency bands (e.g., one or more smaller ranges of frequencies within the first frequency range) where excitation occurs or is believed to occur. For example, in one implementation, an initial sweep may be conducted over a frequency range of 5 Hz to 100 Hz. If noise or excitation is detected at about 18 Hz and at about 40 Hz, the vehicle may be re-tested over two smaller sub-ranges of 15-25 Hz and 35-45 Hz to identify specific frequencies within the smaller sub-ranges where excitation is occurring.

While the vehicle body is being vibrated, the sound produced by the vehicle or vibrations that are induced may be analyzed. This analysis may be performed, for example, using one or more microphones configured to record and transmit the sound (structural borne and airborne noise) to a computer for analysis. Alternatively or additionally, the analysis may be performed by a trained person listening for excessive and/or abnormal noise. Abnormal and/or excessive noises may indicate that the vehicle needs further work before it is ready to be sold (for example, excessive noise during vibration may indicate that a vehicle component such as a rear-view mirror, hood, windshield, etc., may not be securely or effectively attached). In this way, noises produced by the vehicle, while the vehicle body is being vibrated by at least one active suspension actuator, may be analyzed and/or compared to baseline data to determine if the vehicle is in satisfactory condition for sale (e.g., not producing abnormal or excessive noise when vibrated).

In one embodiment, one or more microphones (e.g., an array of microphones) may be used to record sound produced when the vehicle is vibrated at a first frequency or over a first frequency range. The recorded response may be compared to a baseline response. The baseline response may be obtained from, for example, a vehicle of the same make and model (a “reference vehicle”) which has met NVH (noise, vibration, and harshness) requirements of an automotive manufacturer. In certain embodiments, the baseline response may be a previously recorded response of a reference vehicle. If the recorded response is determined to deviate from this baseline response beyond a predetermined threshold or by more than a certain amount, the vehicle may be flagged for further inspection and/or repair. By comparing the recorded response generated by the excited vehicle to the previously generated NVH baseline response, deviations from the baseline may be identified and causes of the deviation(s) determined and resolved.

For example, in an end-of-line BSR test, a deviation at a first frequency or frequency band may indicate an issue with a first component of the vehicle, whereas a deviation at a second frequency or frequency band may indicate an issue with a second component of the vehicle, which may be different from the first component. For end-of-line BSR testing, an automotive manufacturer may compile a library of often-encountered deviations from the baseline response for a particular make and model of a vehicle. If one or more of the often-encountered deviations is detected during BSR testing, the tested vehicle may be flagged for further inspection or repair by a particular department or individual. In some implementations, this process may be automated. For example, an array of microphones may capture a recorded response of a vehicle as the active suspension of the vehicle performs an BSR actuation protocol. The array of microphones may feed data corresponding to the recorded response to a processor which compares the recorded response to the baseline response. Based on any deviations detected, an electronic record of the tested vehicle may be updated with a “pass” or may be tagged for further inspection or repair. In some implementations, a vehicle may be routed for inspection or repair automatically based on the updated electronic record. In some implementations, a work request for the tested vehicle may be generated and assigned to an individual or a department based on the updated record.

In another embodiment, BSR testing may be performed at later points in a vehicle's life (e.g., at 15,000 mile, 25,000 mile, 50,000 mile servicing, etc.). In such an embodiment, later performed iterations of BSR testing (e.g., using the active suspension system to induced vibrations into one or more components of the vehicle) may be used to indicate whether a vehicle needs further servicing or maintenance during, for example, routine servicing appointments. In some embodiments, a response (e.g., a noise response) of the vehicle to vibration at one or more frequencies may be compared with a previously recorded baseline response. For example, after a predetermined mileage is reached (e.g., 50,000 miles of driving), a mechanic may carry out a BSR test and compare the response of the vehicle to a previously recorded response of the same vehicle, a baseline response of a reference vehicle, an expected response of a vehicle of the same make and model at the same mileage, etc. The previously recorded response may be a response that was recorded immediately after manufacture, or at any other appropriate time.

In another embodiment, a method is disclosed for characterizing one or more resonance frequencies of a vehicle equipped with an active suspension system. Acceleration sensors attached to the body of the vehicle may be used to measure an acceleration output of the vehicle in response to various input frequencies and/or amplitudes. First, an actuator of the vehicle's active suspension system is actuated over a range of frequencies to excite a wheel of the vehicle. The output of the acceleration sensors may be recorded and analyzed to determine one or more resonance frequencies of the vehicle. In some implementations, actuation of multiple actuators of the active suspension system may be coordinated. In some implementations, the actuators of the active suspension system may be configured to actuate in a sequence to move the vehicle as if it was driving over a specific road, pattern of bumps, etc. In such implementations, different simulated roads may be commanded to be played via the active suspension system actuators. This may be advantageous as different road inputs may excite resonances in the vehicle, or across a set of vehicles.

Turning to the figures, specific non-limiting embodiments are described in further detail. It should be understood that the various systems, components, features, and methods described relative to these embodiments may be used either individually and/or in any appropriate combination as the disclosure is not limited to only the specific embodiments described herein.

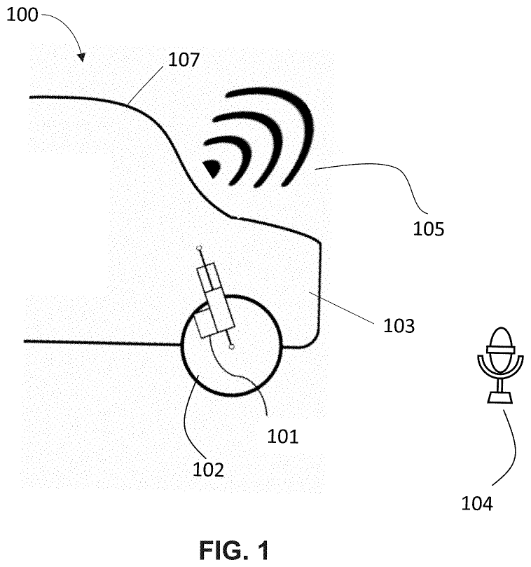

FIG. 1 shows a corner 103 of a vehicle 100 that is equipped with an active suspension system. In this embodiment, an active suspension actuator 101 is controlled to excite a wheel 102 and/or corner of the vehicle 100 at a first frequency or over a range of frequencies. The excitation of the wheel 102 and/or corner may cause motion of a body 107 of the vehicle 100. Such motion may produce noise 105 that may be detected by one or more microphones 104 (e.g., a microphone array) or other appropriate sensors. This detected noise may be recorded and analyzed as described previously herein. For example, the recorded noise may be compared to a reference recording to determine if the vehicle is in a satisfactory condition. Vehicles, or components of vehicles, may be characterized or flagged for further inspection, adjustment and/or repair based on the comparison of the recorded noise to the reference recording. The excitation of the vehicle may be performed when the vehicle is stopped, parked or travelling along a road surface.

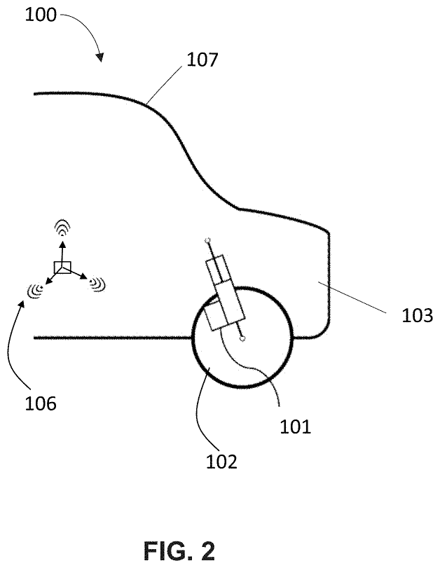

FIG. 2 shows a corner 103 of a vehicle 100 equipped with an active suspension system. In this embodiment, an active suspension actuator 101 is controlled to excite a wheel 102 and/or at least a portion of the vehicle body 107 of the vehicle 100 at a first frequency or over a first range of frequencies. An acceleration response of a body 107 of the vehicle 100 may be measured by, for example, an accelerometer 106. The acceleration detected at accelerometer 106 may then analyzed by comparing the detected acceleration response to the acceleration input to the vehicle 100 by the active suspension actuator 101 to determine the resonance frequencies of the vehicle 100. Alternatively or additionally, the response may be compared to a baseline to determine if there is a fault condition.

In some embodiments a database of anomalous responses to vibration may be generated where specific anomalous responses are correlated with specific vehicle faults. The database may then be used to identify the fault that may be causing an anomalous vibratory response to shaking induced by one or more actuators during a BSR test. As used herein, the phrase “anomalous response” refers to a vibratory response of a vehicle during a BSR test that is effectively different than a reference vibratory response in at least one frequency or one frequency band.

We claim:

1. A method for performing BSR testing on a vehicle equipped with an active suspension system, the method comprising:
actuating at least one actuator of the active suspension system to induce vibration of a vehicle or at least one component of the vehicle in a first frequency range;
recording a first acoustic response generated by the vehicle or the at least one component in response to the induced vibration in the first frequency; and
analyzing the first recorded acoustic response to identify a presence of one or more defects associated with the vehicle or the at least one component.

2. The method of claim 1, further comprising:
actuating the at least one actuator of the active suspension system to induce vibration of the vehicle or the at least one component at a second frequency;
recording a second acoustic response generated by the vehicle or the at least one component in response to the induced vibration at the second frequency; and
analyzing the second acoustic response to identify a presence of one or more manufacturing defects associated with the vehicle or the at least one component.

3. The method of claim 1, wherein analyzing the first recorded acoustic response comprises comparing the first acoustic response to a reference acoustic response.

4. The method of claim 3, wherein analyzing the first recorded acoustic response further comprises determining that the first recorded acoustic response deviates from the reference acoustic response.

5. The method of claim 3, wherein the reference acoustic response comprises an audio response recorded from the vehicle at a previous time.

6. The method of claim 3, wherein the reference acoustic response comprises an audio response recorded from another vehicle of the same make and model as the vehicle.

7. The method of claim 4, further comprising updating, by a controller, an electronic record associated with the vehicle.

8. The method of claim 7, wherein updating the electronic record comprises tagging the vehicle for a repair or a further inspection.

9. The method of claim 1, wherein the at least one component of the vehicle comprises a body of the vehicle.

10. The method of claim 3, wherein analyzing the first recorded audio response further comprises determining that a differential between the first recorded acoustic response and the reference acoustic response is within a predetermined threshold.

11. A method for characterizing resonance frequencies of a vehicle equipped with an active suspension system, the method comprising:
actuating, over a range of frequencies, at least one actuator of the active suspension system to excite a component of the vehicle; and
analyzing an output of at least one accelerometer attached to the vehicle to determine resonance frequencies of the vehicle.

12. The method of claim 11, further comprising analyzing the resonance frequencies of the vehicle and associating at least one of the resonance frequencies with a vehicle component.
